(19) United States
(12) Patent Application Publication
(10) Pub. No.: US 2008/0316100 A1
(43) Pub. Date: Dec. 25, 2008

(54) Method and Apparatus For Antenna Diversity Selection

(75) Inventor: Jens Tingleff, Cambridge (GB)

Correspondence Address: NOVAK DRUCE DELUCA + QUIGG LLP, 1300 EYE STREET NW, SUITE 1000 WEST TOWER, WASHINGTON, DC, 20005, US

(73) Assignee: CAMBRIDGE SILICON RADIO LIMITED, Cambridge (GB)

(21) Appl. No.: 11/575,359

(22) PCT Filed: Feb. 21, 2006
(86) PCT No.: PCT/GB2006/000599

§ 371 Date: May 18, 2007

(30) Foreign Application Priority Data
Feb. 22, 2005 (GB) 0503635.5

(51) Int. Cl. H01Q 3/00

(52) U.S. Cl. 342/374

(57) ABSTRACT

Signal reception apparatus comprising at least two antennas, receiver means having a first mode of operation for assessing the quality of received signals and a second mode of operation for processing received signals for identifying data carried therein, at least two signal paths connectable between the antennas and the receiver means and each capable of demodulating signals received by the antennas and switch means connected between the antennas and the signal paths, the apparatus having an assessment mode of operation in which each antenna is connected by the switch means to the receiver means via a single respective one of the signal paths and in which the receiver means operates in its first mode of operation to assess the quality of received signals from each antenna, and a normal mode of operation in which a single antenna is connected by the switch means to the receiver means via all of the signal paths and in which the receiver means operates in its second mode of operation for processing received signals for identifying data carried therein.

The present invention relates to a method and apparatus for selecting an antenna. In particular, but not exclusively, the invention relates to the selection of an antenna in a transceiver station of a communication system.

Developments in wireless communication systems have led to a demand for higher quality and reliability. Antenna diversity is one available means to mitigate the effects of multipath interference which can impact negatively on such quality or reliability.

The principle of diversity is centred upon the concept that if several replicas of a data signal can be transmitted or received simultaneously then there is an improved chance that at least one of the signals will not be degraded. Various diversity techniques are available, such as frequency diversity, time diversity and spatial diversity.

In spatial diversity multiple transmitting or receiving antennas are utilised. The spacing between the antennas is selected so as to improve the chance of at least one of the antennas being able to transmit or receive a strong signal. Typically this is achieved by spacing the adjacent antennas apart by upwards of half the radio wavelength.

Spatial diversity of antennas may be included in user equipment (UE) in a wireless communication system or in a base station (BS). It will be understood that the present invention is not limited in its use to either of these applications, but rather is applicable to any situation in which multiple antennas are provided and one of the antennas should be selected for use during normal operation.

Various UE such as computers (fixed or portable), mobile telephones, personal data assistants or organisers and so on are well known to the skilled person and these can be used to communicate with other UE in a communication system or to access the internet to obtain services. Mobile UE are often referred to as a mobile stations (MS) and provide a means which is capable of communication via a wireless interface with another device such as a base station of a mobile telecommunication network or any other station. Such a mobile UE can be adapted for voice, text message or data communication via the wireless interface.

In the past one problem associated with such spatial diversity is that in order to select which antenna is providing the best signal the full receive chain (that is the circuitry and signal processing components required to achieve the necessary signal filtering and conditioning for normal operation), must be provided for each antenna. However once one of the antennas is selected (for example as providing the best/strongest signal) only the signals from that antenna and its associated receive chain are utilised. The remaining antenna/s and associated receive chain/s circuitry are redundant. This is a waste of hardware, power and resources.

It is an object of the present invention to at least partly mitigate the above-mentioned problem.

According to one embodiment of the present invention, there is provided a signal reception apparatus comprising at least two antennas, receiver means having a first mode of operation for assessing the quality of received signals and a second mode of operation for processing received signals for identifying data carried therein, at least two signal paths connectable between the antennas and the receiver means and each capable of demodulating signals received by the antennas and switch means connected between the antennas and the signal paths, the apparatus having an assessment mode of operation in which each antenna is connected by the switch means to the receiver means via a single respective one of the signal paths and in which the receiver means operates in its first mode of operation to assess the quality of received signals from each antenna, and a normal mode of operation in which a single antenna is connected by the switch means to the receiver means via all of the signal paths and in which the receiver means operates in its second mode of operation for processing received signals for identifying data carried therein.

Preferably, during the normal mode of operation the antennas other than the single antenna are not connected to any of the signal paths.

Preferably, the received signals are received by the at least two antennas.

The receiver means may comprise a comparison unit arranged to assess the quality of received signals during the first mode of operation and to output a signal identifying the antenna receiving the highest quality signals in dependence on that assessment and a detection unit arranged to process the received signals during the second mode of operation for identifying the data carried therein.

The apparatus may also comprise further switching means, the further switching means being connected between the receiver means and the signal paths such that the comparison unit is connected to all of the signal paths during the first mode of operation of the receiver means and the detection unit is connected to all of the signal paths during the second mode of operation of the receiver means.

The apparatus may also comprise a control unit arranged to output at least one mode selection signal indicative of the mode of operation of the apparatus, the switch means being responsive to the mode selection signal to connect each antenna to a single respective one of the signal paths during the assessment mode of operation and to connect a single antenna to all of the signal paths during the normal mode of operation and the further switching means being responsive to the mode selection signal to connect the comparison unit to all of the signal paths during the assessment mode of operation and to connect the detection unit to all of the signal paths during the normal mode of operation.

The control unit is preferably arranged to receive the signal output from the comparison unit identifying the antenna receiving the highest quality signal and to output a mode selection signal containing an identification of that antenna, the switch means being responsive to that mode selection signal to connect the identified antenna to all of the signal paths.

The comparison unit may be arranged to assess the quality of received signals by determining the signal strength of the received signals, the bit error rate of the received signals or by detecting a preamble signal in a signal received by each antenna. Preferably, the preamble signal comprises an RF burst preamble.

Preferably, each antenna is connected to the signal paths via a respective low noise amplifier.

Each signal path may comprise a receive chain. Each signal path may include a mixer means and a channel filter means.

Preferably, the apparatus further comprising phase-shifter means and a local oscillator which provides output signals to the mixer means in each of said signal paths.

The apparatus may be disposed in a mobile station of a communication system. Alternatively, the apparatus may be disposed in a base station of a communication system.

According to a second embodiment of the present invention, there is provided a method for operating a signal reception apparatus comprising at least two antennas, receiver means having a first mode of operation for assessing the quality of received signals and a second mode of operation for processing received signals for identifying data carried therein, at least two signal paths connectable between the antennas and the receiver means and each capable of demodulating signals received by the antennas and switch means connected between the antennas and the signal paths, the method comprising the steps of: operating the apparatus in an assessment mode of operation by the switch means connecting each antenna to the receiver means via a single respective one of the signal paths, the receiver means operating in its first mode of operation to assess the quality of received signals from each antenna; and operating the apparatus in a normal mode of operation by the switch means connecting a single antenna to the receiver means via all of the signal paths, the receiver means operating in its second mode of operation for processing received signals for identifying data carried therein.

According to a third embodiment of the present invention, there is provided a method for receiving data in a data receiver of a wireless communication system, the method comprising: initiating an assessment mode of operation during which the quality of signals received at each of at least two antennas of said data receiver is determined, each antenna being connected to a single respective one of a plurality of signal paths during the assessment mode of operation; selecting one of the at least two antennas in dependence on the determined signal qualities; connecting the selected one antenna to the plurality of signal paths during a normal mode of operation; and during said normal mode of operation receiving data via the selected one antenna.

Embodiments of the present invention will now be described hereinafter by way of example only with reference to the accompanying drawings in which:

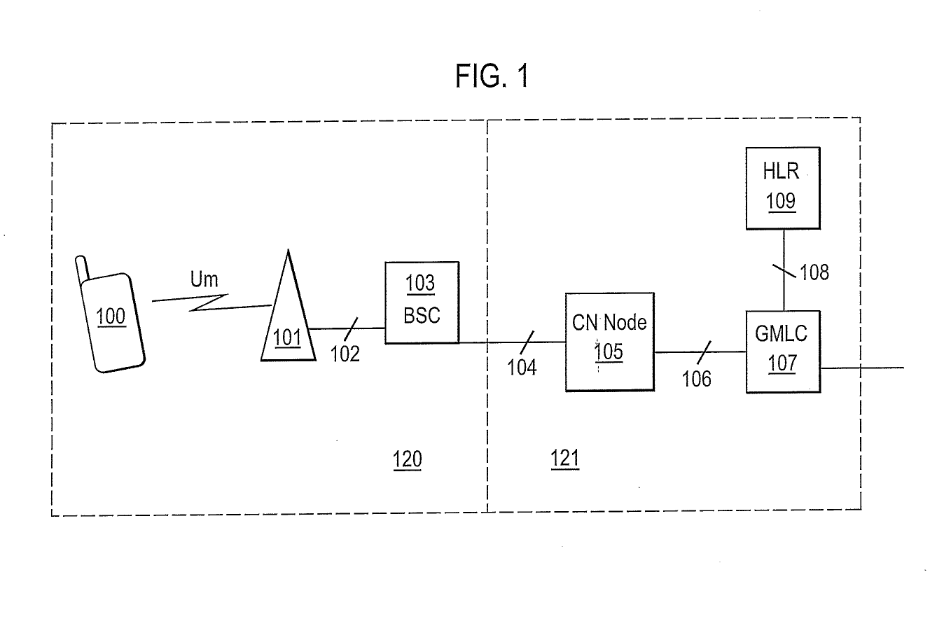

FIG. 1 illustrates a wireless communication system.

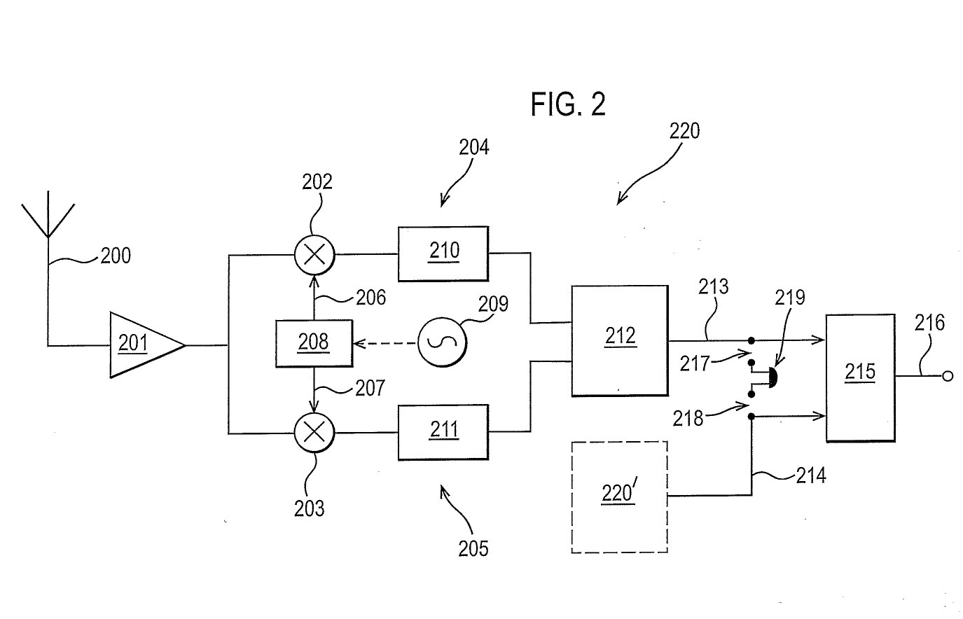

FIG. 2 illustrates a prior art system for antenna selection.

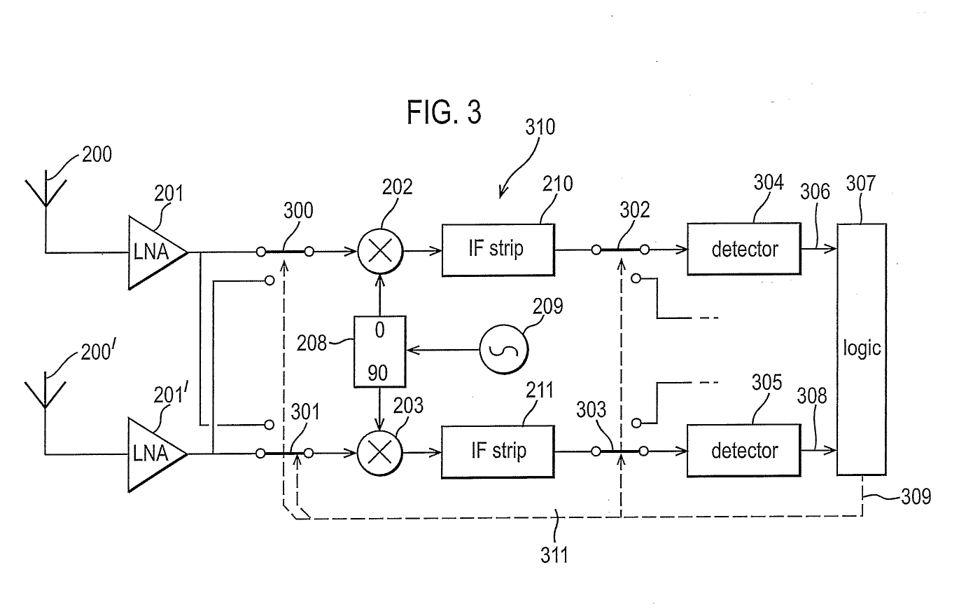

FIG. 3 illustrates an assessment mode of operation.

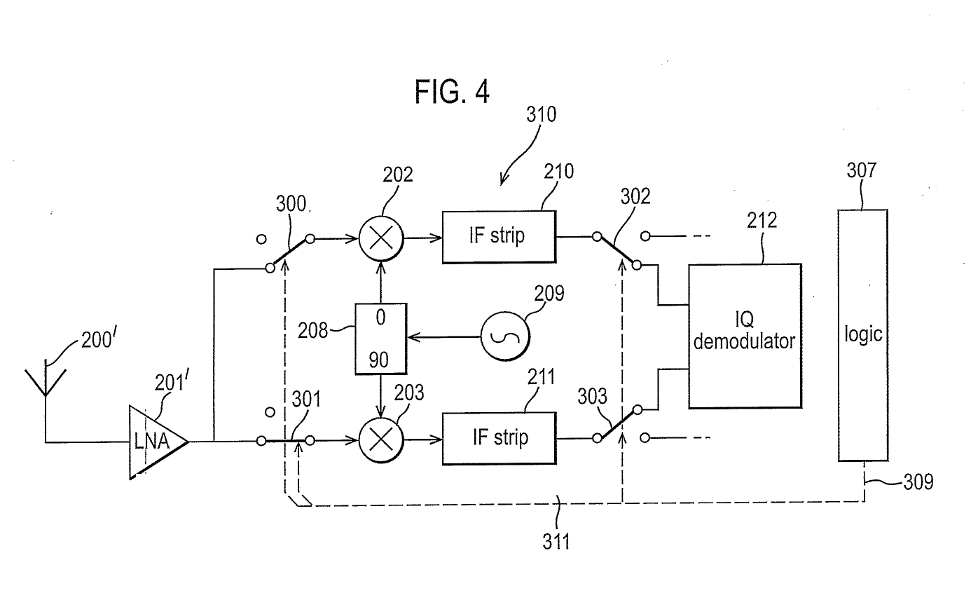

FIG. 4 illustrates a normal mode of operation.

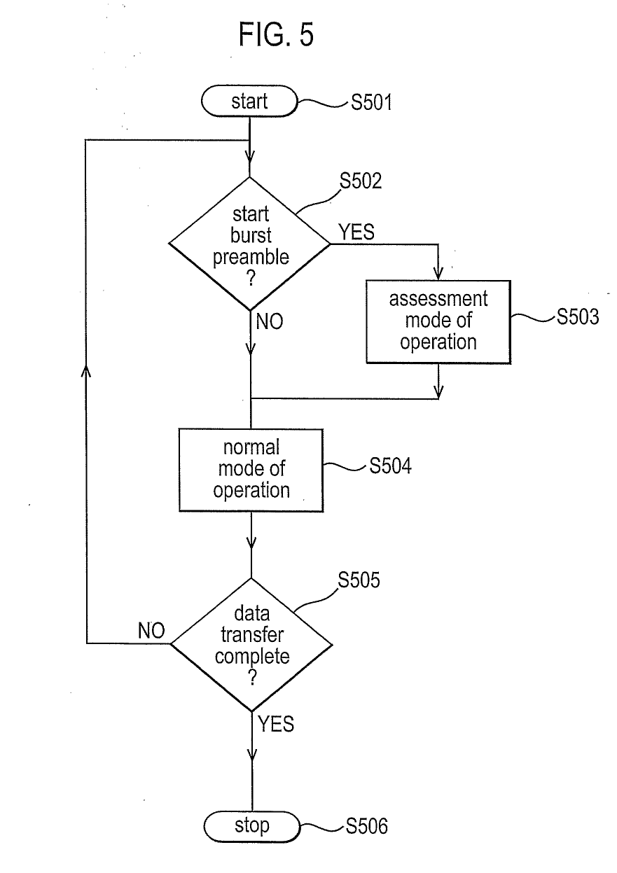

FIG. 5 illustrates a method for receiving data.

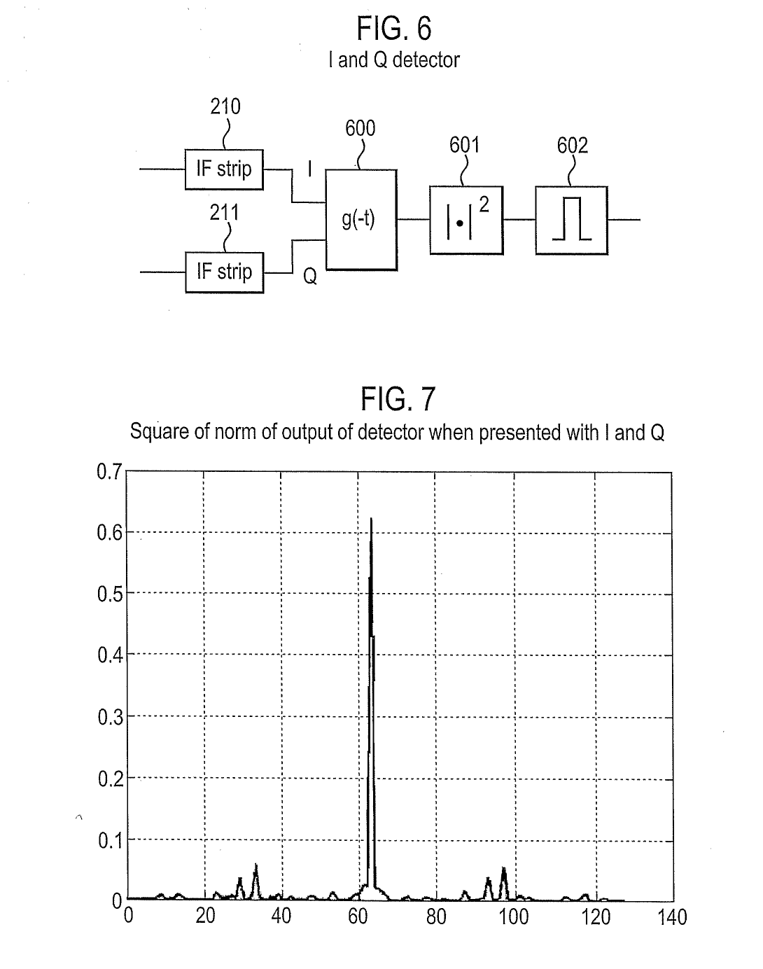

FIG. 6 illustrates a detector having in-phase and quadrature input signals.

FIG. 7 illustrates a detection signal resulting from both in-phase and quadrature detection signals.

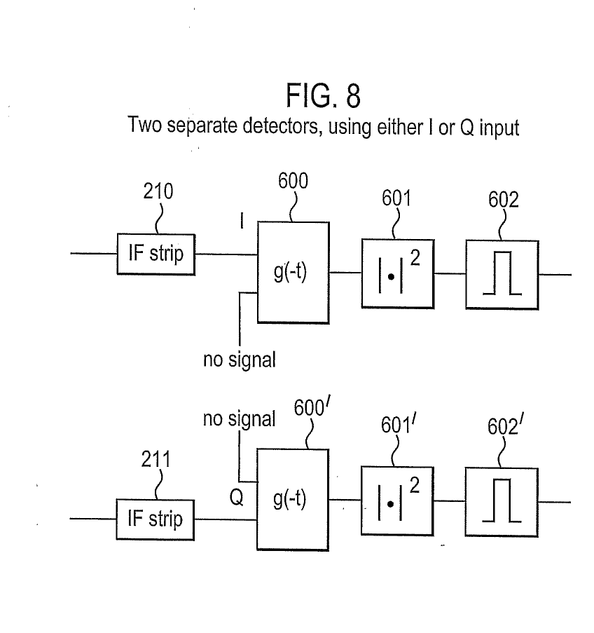

FIG. 8 illustrates two detectors having either an in-phase or a quadrature input signal.

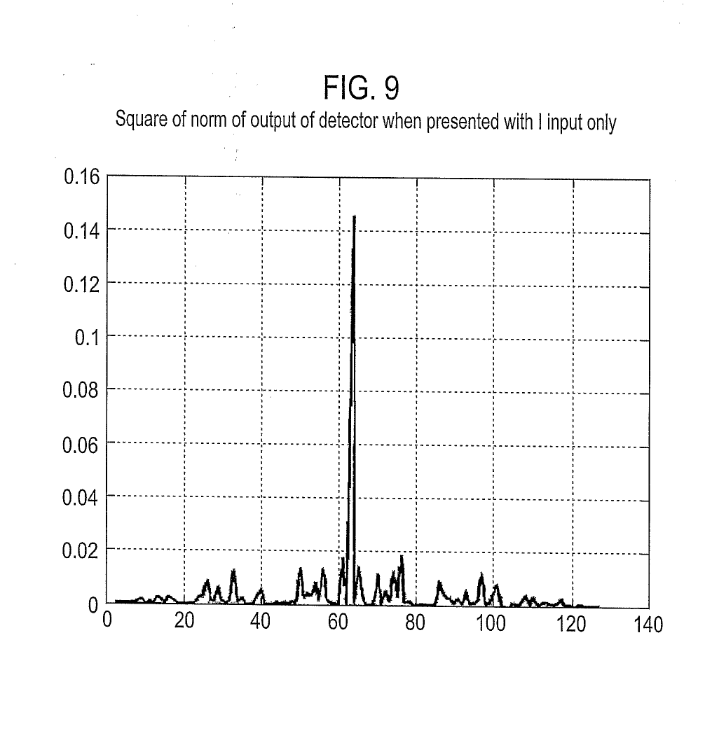

FIG. 9 illustrates a detection signal resulting from an in-phase signal.

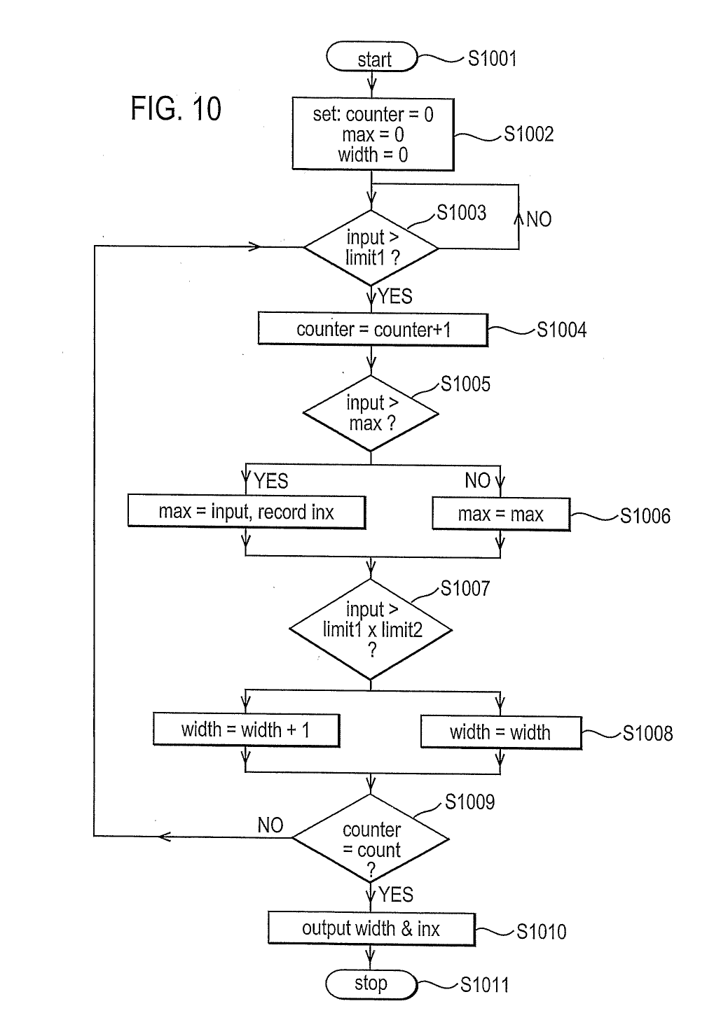

FIG. 10 illustrates a method for detecting signal peaks.

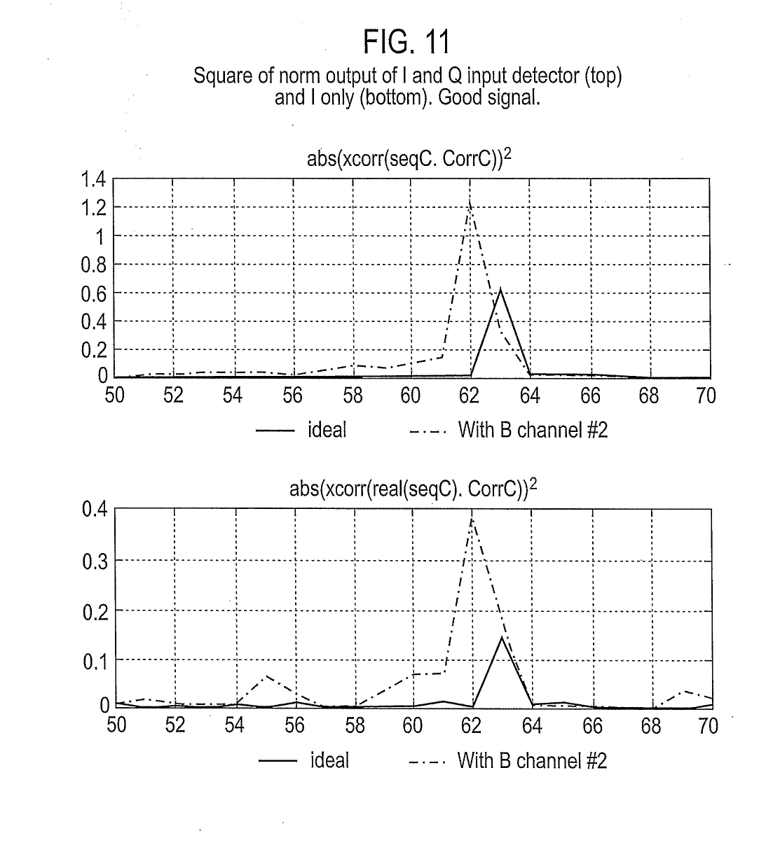

FIG. 11 illustrates a detection signal generated from a good received signal.

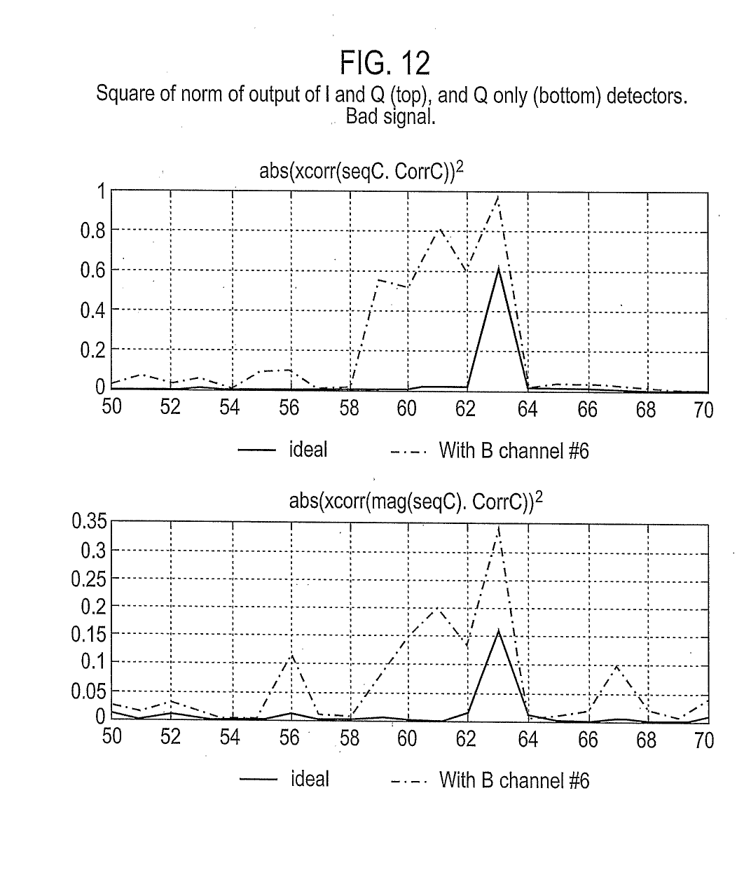

FIG. 12 illustrates a detection signal generated from a bad received signal.

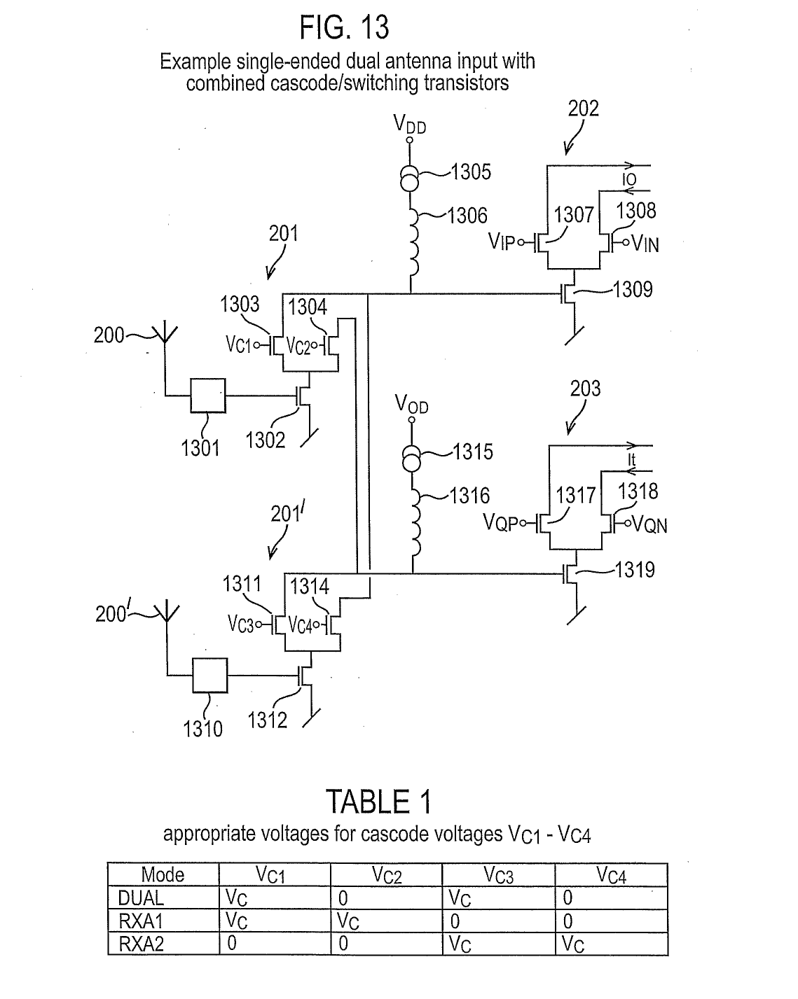

FIG. 13 illustrates an antenna input with cascode transistors.

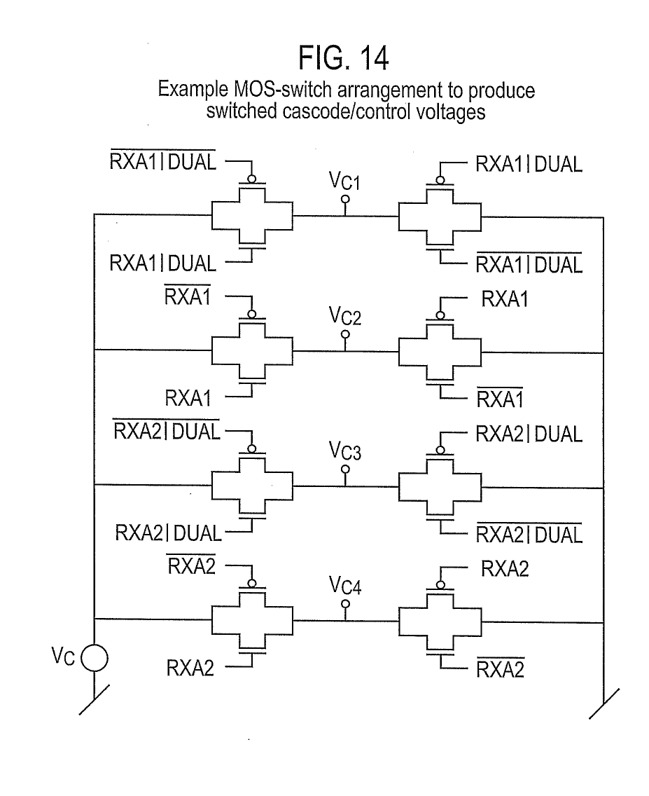

FIG. 14 illustrates a switching arrangement to produce control voltages.

In the drawings like reference numerals referred to like parts.

FIG. 1 illustrates a general logical architecture for a wireless communication system. It will be understood that embodiments of the present invention can be applied to other communication systems.

A mobile station (MS) 100 may be a short-range radio transceiver, for example a Bluetooth® transceiver or another device that has a transceiver adapted for radio access. The MS can communicate with another such device, which may be a base station (BS) 101 over a radio interface.

FIG. 2 illustrates a receive chain 220 for an antenna 200 according to the prior art. The antenna may be situated in the BS 101 or MS 100 or any other node in the communication system where spatial diversity is required. One receive chain is required to enable signals to be received at the antenna 200 and decoded to provide an output. The receive chain includes a low noise amplifier 201 connected to the antenna 200. This provides some filtering of the wide band signal received at the antenna. The output from the low noise amplifier 201 is input into two mixer units 202, 203. The receive chain contains two identical signal paths for signal conversion, one of these 204 generates in-phase (I) signals and one signal path 205 generates a quadrature (Q) signal. This is well known in the art and these signals are provided by mixing the output of the low noise amplifier 201 with output signals 206, 207 from a phase-shifter 208. The phase-shifter is itself provided with an input signal from a local oscillator 209. Each of the signal paths 204, 205 includes an IF strip 210, 211 respectively, which operate as channel filters to allow a selected channel to be filtered out of the signals output from mixers 202, 203. The outputs from the two IF strips 210, 211 are input into an IQ demodulator 212 as is known in the art. The output 213 from the demodulator 212 provides a processed output signal from which the data encoded in the signal received at the antenna 200 may be extracted.

By mixing the output signal from the low noise amplifier with the local oscillator signal, all incoming radio signals are changed to the same frequency, known as the intermediate frequency (IF). As the IF strip is designed to provide high gain and good selectivity, it is important that the gain and selectivity of the IF strips are not dependent on the frequency of the received signal. If the IF frequency is constant, then the IF strips can be designed for optimum gain and bandwidth, which is then the same for all stations.

In summary, the receiver circuitry 220 uses one LNA 201, two mixers 202, 203 and two IF strips 210, 211 in front of a demodulator 212 which uses both I and Q signals. The two signals I and Q are generated by mixing the output from LNA 201 by phase-shifted version of the local oscillator 209 output signal. These are the output signals 206, 207 from the phase-shifter 208. As the manner in which the signals are processed is well known to those skilled in the art, a detailed discussion of this will not be included herein for the sake for brevity.

A spatial diversity receiver may conventionally comprise two antennas, known as dual-antenna receivers. Therefore, a similar circuit 220′ containing elements analogous to those of the receive chain 220 may be provided for a second antenna 200′ (not shown).

The output signals 213, 214 from both the first and second receive chains are input into a two input comparison block 215, which is arranged to compare the output signals from the two receive chains and provide an output signal 216 indicating which of the antennas 200, 200′ should be selected for normal operation. During an assessment mode of operation, when a choice is made for which antenna will be utilised during the normal mode of operation, the output 213, 214 from the two respective receive chains 220, 220′ are input into the comparison block 215 via respective switches 217, 218.

The comparison block 215 operates to compare the output signals from the two receive chains, 220, 220′ to establish which of the antennas should be used to receive further signals. During the assessment mode of operation, measurements are taken from the signals received by the two antennas 200, 200′ in order to assess which antenna is at that moment providing the best signal. This assessment could be made according to any appropriate characteristic of the received signal, such as signal strength, bit error rate etc. The output 216 from the comparison block indicates which of the antennas is to be selected.

Once the antenna is selected the comparison block is switched out of action via switching elements 217, 218 which are controlled by signal 216. As an alternative the signal 216 can be used to control other processing blocks (not shown) which in turn control the switches 217, 218. During the normal mode of operation the output 213 or 214 from the respective receive chain 220, 220′ is connected to the output 219 from which the data from the transmitted signal received at the selected antenna maybe extracted.

According to the prior art for MS 100 or BS 101 having multiple antenna to support spatial diversity each antenna requires the receive circuitry 220, 220′ described hereinabove. It will be understood that once one of the multiple antenna is selected the circuitry 220, 220′ associated with the antenna(s) not selected is redundant and is no longer used until a further antenna selection process is initiated.

FIG. 3 illustrates apparatus which overcomes this problem in accordance with an embodiment of the present invention. FIG. 3 includes two antennas 200 and 200′ with respective low noise amplifiers 201, 201′. It will be understood that FIG. 3 shows two antennas for illustration purposes only and the present invention is not limited to use with this number of antennas.

The two antennas 200 and 200′ form part of a single receive chain. As with the receive chain 220 of FIG. 2, there are two signal paths 310, 311 for producing both in-phase and quadrature signals. These signals are generated by mixing the output signals from the low noise amplifiers with signals generated in phase-shifter 208 and local oscillator 209. The antennas may be connected to one, both or neither of the signal paths 310, 311 via low noise amplifiers 201, 201′ and switching elements 300 and 301. The output from each of the mixers 202, 203 are input into IF strips 210, 211 respectively. These provide channel filtering to extract the received signal from the noise picked up by the antenna as is known in the art. The outputs from the two IF strips 210, 211 are connected to respective detectors 304 and 305 via switching elements 302 and 303.

During the assessment mode of operation, when a signal characteristic of the signal received by both antenna 200 and 200′ is measured, one of the antennas is connected to the signal path for generating in-phase signals (the I-channel, 310) and the other antenna is connected the signal path for generating quadrature signals (the Q-channel, 311). The resulting signals output from each signal path are fed into two detectors 304, 305. In accordance with the assessment mode of operation, in FIG. 3 switching element 300 is in a first position and the output signal from low noise amplifier 201 is fed into signal path 310. Likewise, switching element 301 is in a second position and the output signal from low noise amplifier 201′ is fed into signal path 311. Switching elements 302 and 303 are both in a first position so that output signals from IF strip 210 and IF strip 211 are fed into detectors 304 and 305 respectively.

Detector 304 outputs a signal 306 which forms a first input into antenna selection block 307. Detector 305 likewise outputs a signal 308 as a second input into antenna selection block 307.

According to a preferred embodiment, the receiver is arranged for receiving signals in the form of bursts. Each detector 304, 305 is arranged to detect the quality of a start preamble of an RF burst in the received signal at its respective antenna. This method of detection will be described in more detail below. However, it should be understood that the present invention is not limited to detectors that operate in this manner but rather any form of detector which can be used to identify a quality or other characteristic of the received signal at the antennas 200, 200′ may be used.

During the assessment mode of operation, the detectors 304, 305 output an indication of the quality of the signal received by the antenna to which the detector is connected. Preferably, this indication is a single value. The output from the detectors is input into antenna selection block 307 that selects which of the antennas 200, 200′ is to be used during normal mode of operation on the basis of the indication of received signal quality output by the detectors.

FIG. 4 illustrates a normal mode of operation in which the antenna 200′ has been selected to provide receive signals. The switches 300 and 301 are set under control of signal 309 from the antenna selection block so as to connect the outputs from low noise amplifier 201′ to the mixers 202 and 203 respectively. The mixers 202, 203, phase-shifter 208 and local oscillator 209 operate in a manner well known to those skilled in the art and provide input into the channel filters 210 and 211 respectively. Switches 302 and 303 are controlled via output signal 309 from antenna selection block 307 to connect the outputs to an I Q demodulator 212, as is known in the art. The switches 302 and 303 disconnect the detection blocks 305 and 304 shown in FIG. 3 from the outputs from the channel filters 210 and 211. The output 400 from the I Q demodulator block 212 provides an output from which the data transmitted and received at the antenna 200′ maybe extracted as is known in the art.

FIG. 5 illustrates the steps followed during data transmission and receipt at an antenna. At step S501 the data transfer is noted. This can be identified in many ways depending upon the type of data transferred over the wireless link to the antenna 200, 200′. Examples to which the present invention is applicable are Bluetooth and wireless LAN systems such as the IEEE 802.11 wireless LAN and ETSI HIPERLAN type 2 standards. In each of these a standard data transmission signal proceeds data transfers. Thereafter data is transferred across a wireless link in data bursts. These data bursts have a preamble of predetermined length and data content together with thereafter a payload which includes the data to be transferred. Embodiments of the present invention can select the optimum antenna to be used upon receipt of each burst preamble in a data stream. Alternative embodiments can be used to select the antenna less often. The receipt of a start burst preamble is identified at step S502. If such a burst preamble is identified an assessment mode of operation is begun (step S503) to select which of the antennas 200,200′ should be selected to received the data. The selected antenna will typically be the antenna which is at that time providing the strongest received signal. If no burst preamble is detected then the data being transmitted comprises the payload of a burst. The payload data is detected during a normal mode of operation at step S504 during the normal mode of operation the output 400 from the selected antenna can be monitored to detect whether data transfer has been completed. This is indicated in FIG. 5 by step S505. If no signal is indicated the steps S502 to S504 are repeated: When all transmitted data has been sent and received at the antenna this fact is signified by a data transfer complete signal in the transmitted data. This is identified and the assessment mode and normal mode of operation can be suspended. This is step S506.

During transmission a signal is typically subject to fading, for example through multipath propagation of the signal. Also, any received signal is a combination of the transmitted signal and noise, which causes further degradation of the transmitted signal. An objective of using receive antenna diversity is therefore to detect the signal that has degraded the least during transmission. Therefore, a preferred method for comparing received signals according to the present invention is to determine which received signal is closest to the transmitted signal. If a standard data transmission such as that described above is used, then a measure of the correlation between a transmitted signal and a received signal can be generated by comparing the burst preamble of the received signal with a known synchronisation sequence to which the burst preamble corresponds. The detection process will be described briefly. As this process is well-known in the art, a detailed discussion will not be included herein.

A typical detector as is well-known in the art is illustrated in FIG. 6. The detector comprises generally a correlator 600, an averaging means 601 and a peak detector for detecting the peak value of the resulting signal 602. The outputs from two IF strips 210, 211 are input into the correlator 600, which is arranged to calculate the cross-correlation between the IF signals and the known synchronisation sequence. The output from the correlator 600 is processed by the averaging means 601 to produce a detection signal that gives a measure of the of the correlation value between the IF signals and the synchronisation sequence. A typical detection signal is illustrated in FIG. 7. The detection signal in FIG. 7 was generated using transmit and receive signals according to a telecommunications standard in which the synchronisation sequence and preamble are 64 bits long. Hence, as illustrated, the detection signal shows a peak correlation at sample 63.

The detectors according to an embodiment of the present invention are preferably arranged to receive just one of the in-phase or quadrature components from the IF strip as illustrated in FIG. 8. The detector is implemented similarly to before, but with one input of the correlation means forced to zero. FIG. 9 shows a detection signal output by a detector having as an input only the in-phase component of the received signal of FIG. 7. As shown in FIG. 9, the detection signal still has a peak at bit number 63 but the peak has a smaller amplitude.

The detector in FIG. 8 is shown generally in terms of its functional blocks. This is for ease of illustration only and it should be understood that the present invention is not limited to a detector having discrete functional components according to this depiction. In particular, the detector functions could be implemented in either hardware or software. For the purposes of example, a suitable correlation means could be a matched filter and a suitable averaging means could be a square-norm circuit.

It will be understood that the detectors 304,305 can be provided to determine a characteristic of the signals received by the antennas 200, 200′ in various different techniques without departing from the scope of the present invention.

The detection signal is passed to the peak detecting means 602, 602′ to determine a measure of the correlation between the received signal and the known synchronisation sequence. Preferably, the peak detecting means generates a single value that can be used to compare the signals received by the antennas. Although the peak detection means are shown as being a part of the detector in FIG. 8, this step could also be implemented in the antenna selection block, as would be understood by one skilled in the art.

FIG. 10 shows the steps of a suitable method for determining a single value to represent the correlation between a received signal and the synchronisation sequence. At step S1001 the detection signal is received by the peak detection means. At step S1002 the variables COUNTER, MAX and WIDTH are set to zero. At step S1003 the detection signal is sampled and it is determined whether or not the sampled value of the detection signal is above a predetermined value LIMIT1. If the sampled value is greater than LIMIT1, then during the following predetermined number (COUNT) of cycles, the detection means finds the maximum level MAX of the measurement signal, the index or sample number INX having the maximum value and the number of samples WIDTH around this sample at which the value of the measurement signal was greater than a predetermined multiple LIMIT2 of the maximum level. Therefore, at step S1003 the detection means determines whether or not the sampled value is greater than LIMIT1. If not, the detection means repeats step S1003 with another sample. If it is, the detection means increments the counter by one (S1004) and checks whether the input sample is greater than the current maximum value. If it is, MAX is set to the sample value and the corresponding sample number INX is recorded S1006). If not, MAX remains unchanged. At step S1007 the detection means checks whether the sample has a higher value than LIMIT1 multiplied by LIMIT2. If the answer is yes, WIDTH is increased by one in step S1008. If the answer is no, WIDTH is unchanged. At step S1009 it is checked whether COUNTER is equal to COUNT. If not, the process is repeated for the next sample. Otherwise, WIDTH and INX are output from the peak detector at step S1010.

FIGS. 11 and 12 illustrate detection signals generated from a good received signal and a bad received signal respectively. For the purposes of example, consider if LIMIT1 AND LIMIT2 are both set to 0.125 and COUNT is set to 10. Applying the steps above and using these values on the good measurement signal (generated from an in-phase signal) in FIG. 11, the INX value would be 62 and the WIDTH value would be 1. Applying the same steps to the bad measurement signal of FIG. 12 (generated from a quadrature signal), INX would be at 63 and WIDTH would be 3.

The WIDTH output value is a suitable measure for comparing the quality of the received signals from the different antennas as the received signal should preferably show a well-defined, narrow spike corresponding to a strong correlation between the preamble and the synchronisation signal.

The above explanation is by way of example only and in practice any suitable comparison method could be used.

The antenna selection block 307 receives the signals 306 and 308 from the detection blocks 304, 305 respectively. In the preferred embodiment the antenna selection block 307 includes logic circuitry as will be described below. It will however be understood that the present invention is not limited to use of such circuitry but rather signal processing could be used or any manner of device which is able to compare the respective outputs from detectors 304 and 305 to detect which antenna 200, 200′ is at that moment providing the best signal.

The antenna selection block 307 outputs control signals shown generally at 309, which indicate which one of the antenna 200, 200′ should be selected to receive transmitted signals. The signals 309 control switches 300, 301, 302 and 303.

An example of a suitable switching circuit is shown in FIG. 13. The circuit diagram shows two antennas 200, 200′ connected through antenna adaptor networks 1301, 1310 to the inputs of the low-noise amplifiers 201, 201′. The additional switches 300, 301 that are required over the prior art receiver between the low noise amplifiers 201, 201′ and the mixers 202, 203 are realised by having two cascode transistors 1303, 1304 and 1311, 1314 in each low noise amplifier. The appropriate signals can be passed through the low noise amplifier to the reactive-load/bias-network and thereby to the input of the mixers according to control voltages V_{C1} to V_{C4}. The cascoded transistors ‘switch on’ i.e. become conducting when the control voltage input to their gate becomes high. For example, when one V_{C1} is high transistor 1303 conducts and the received signal from antenna 200 is effectively connected to mixer input 1309.

The first mixer uses input voltages V_{IP}/V_{IN} from the local oscillator. This mixer therefore forms part of the I-channel. Similarly, the second mixer uses input voltages V_{QP}/V_{QN} from the local oscillator and forms part of the Q-channel.

Table 1 gives the appropriate voltages for cascode control voltages V_{C1} to V_{C4} according to the operational mode of the receiver. By asserting the DUAL state the signal from antenna 200 is passed through to one output, which is connected to the I-channel, and the signal from antenna 200′ is passed through to the other output, which is connected to the Q-channel. Asserting the RXA1 state causes antenna 200 to be selected such that the output signal from that antenna 200 is passed to both the I-channel and the Q-channel and asserting the RXA2 state causes antenna 200′ to be selected and the output signal from that antenna to be passed to both the I-channel and the Q-channel.

FIG. 14 shows an example circuit for producing the cascode control voltages. The control voltages V_{C1} to V_{C4} can be switched between ground and a cascode voltage V_{C} using a logic circuit such as that illustrated. The circuit uses an arrangement of MOS transistors controlled by the DUAL, RXA1 and RXA2 modes to generate the appropriate control voltages V_{C1} to V_{C4}.

Embodiments of the present invention can be adapted for use with diversity reception radio receivers. As such embodiments can provide a data communication receiver for providing diversity reception of radio signals containing data bits. Unlike prior art receiver systems which select receive antennas based upon signal quality using dual receive chains the additional circuitry and hardware required by embodiments of the present invention is greatly reduced.

Embodiments of the present invention provide the possibility to perform synchronisation to a preamble signal contained within the transmitted signal, received by the antenna to be carried out regularly. Indeed antennas can be selected on every received data burst of the data stream transmitted over a wireless interface.

Other advantages provided by embodiments of the present invention are that if any switches are required between the antennas and low noise amplifiers (for example, in order to isolate a transmit output) this has no effect upon the proper functioning of the present invention. Furthermore embodiments of the present invention can be implemented using communally available hardware without a requirement for modification. For example the local oscillator IF strip and demodulator functions can be provided by well-known hardware.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1. Signal reception apparatus comprising:
at least two antennas;
receiver means having a first mode of operation for assessing the quality of received signals and a second mode of operation for processing received signals for identifying data carried therein;
at least two signal paths connectable between the antennas and the receiver means and each capable of demodulating signals received by the antennas; and
switch means for selectively connecting the antennas and the signal paths;
the apparatus having an assessment mode of operation in which each antenna is connected by the switch means to the receiver means via a single respective one of the signal paths and in which the receiver means operates in its first mode of operation to assess the quality of received signals from each antenna, and a normal mode of operation in which a single antenna is connected by the switch means to the receiver means via all of the signal paths and in which the receiver means operates in its second mode of operation for processing received signals for identifying data carried therein.

2. Apparatus as claimed in claim 1, wherein during the normal mode of operation the antennas other than the single antenna are not connected to any of the signal paths.

3. Apparatus as claimed in claim 1, wherein the received signals are received by the at least two antennas.

4. Apparatus as claimed in claim 1, wherein the receiver means comprises:
a comparison unit arranged to assess the quality of received signals during the first mode of operation and to output a signal identifying the antenna receiving the highest quality signals in dependence on that assessment; and
a detection unit arranged to process the received signals during the second mode of operation for identifying the data carried therein.

5. Apparatus as claimed in claim 4, wherein the apparatus comprises further switching means, the further switching means being connected between the receiver means and the signal paths such that the comparison unit is connected to all of the signal paths during the first mode of operation of the receiver means and the detection unit is connected to all of the signal paths during the second mode of operation of the receiver means.

6. Apparatus as claimed in claim 5, wherein the apparatus further comprises:
a control unit arranged to output at least one mode selection signal indicative of the mode of operation of the apparatus;
the switch means being responsive to the mode selection signal to connect each antenna to a single respective one of the signal paths during the assessment mode of operation and to connect a single antenna to all of the signal paths during the normal mode of operation; and
the further switching means being responsive to the mode selection signal to connect the comparison unit to all of the signal paths during the assessment mode of operation and to connect the detection unit to all of the signal paths during the normal mode of operation.

7. Apparatus as claimed in claim 6, wherein the control unit is arranged to receive the signal output from the comparison unit identifying the antenna receiving the highest quality signal and to output a mode selection signal containing an identification of that antenna, the switch means being responsive to that mode selection signal to connect the identified antenna to all of the signal paths.

8. Apparatus as claimed in claim 4, wherein the comparison unit is arranged to assess the quality of received signals by determining the signal strength of the received signals.

9. Apparatus as claimed in claim 4, wherein the comparison unit is arranged to assess the quality of received signals by determining the bit error rate of the received signals.

10. Apparatus as claimed in claim 4, wherein the comparison unit is arranged to assess the quality of received signals by detecting a preamble signal in a signal received by each antenna.

11. Apparatus as claimed in claim 10, wherein said preamble signal comprises an RF burst preamble.

12. Apparatus as claimed in claim 1, wherein each antenna is connected to said signal paths via a respective low noise amplifier.

13. Apparatus as claimed in claim 1, wherein each signal path comprises a receive chain.

14. Apparatus as claimed in claim 1, wherein each signal path includes a mixer means for mixing a signal from an antenna with a reference signal, and a channel filter means for filtering a mixed signal from said mixer means.

15. Apparatus as claimed in claim 14, further comprising phase-shifter means and a local oscillator which provides output signals to the mixer means in each of said signal paths.

16. Apparatus as claimed in claim 1, wherein said apparatus is disposed in a mobile station of a communication system.

17. Apparatus as claimed in claim 1, wherein said apparatus is disposed in a base station of a communication system.

18. A method for operating a signal reception apparatus comprising at least two antennas, receiver means having a first mode of operation for assessing the quality of received signals and a second mode of operation for processing received signals for identifying data carried therein, at least two signal paths connectable between the antennas and the receiver means and each capable of demodulating signals received by the antennas and switch means connected between the antennas and the signal paths, the method comprising the steps of:
operating the apparatus in an assessment mode of operation by the switch means connecting each antenna to the receiver means via a single respective one of the signal paths, the receiver means operating in its first mode of operation to assess the quality of received signals from each antenna; and
operating the apparatus in a normal mode of operation by the switch means connecting a single antenna to the receiver means via all of the signal paths, the receiver means operating in its second mode of operation for processing received signals for identifying data carried therein.

19. A method for receiving data in a data receiver of a wireless communication system, the method comprising:
initiating an assessment mode of operation during which the quality of signals received at each of at least two antennas of said data receiver is determined, each antenna being connected to a single respective one of a plurality of signal paths during the assessment mode of operation;
selecting one of the at least two antennas in dependence on the determined signal qualities;
connecting the selected one antenna to the plurality of signal paths during a normal mode of operation; and
during said normal mode of operation receiving data via the selected one antenna.

20-21. (canceled)
